(19) United States
(12) Patent Application Publication
(10) Pub. No.: US 2002/0004899 A1
(43) Pub. Date: Jan. 10, 2002

(54) Secure mail proxy system, method of managing security, and recording medium

(75) Inventor: Tomihiko Azuma, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/897,323

(22) Filed: Jul. 2, 2001

(30) Foreign Application Priority Data
Jul. 5, 2000 (JP) 2000-204112

(51) Int. Cl. H04L 9/00; G06F 15/167

(52) U.S. Cl. 713/152; 380/277; 713/153; 709/206

(57) ABSTRACT

A system and method that can ensure the security of electronic-mail on the Internet regardless of whether security capabilities are present on the client side, in which a proxy server (4) is arranged between the Internet (5) and a mail server (2) on a LAN (1) and in which a mail server (2) that has received ordinary-text mail from the mail client (3) sends mail that is addressed to a destination outside the LAN to the proxy server (4) as unaltered ordinary text, and proxy server (4): encrypts the ordinary-text mail, attaches the signature of the mail originator, and transmits the encrypted mail with attached signature to the Internet (5), checks for falsification of encrypted mail with attached signature from the Internet, decrypts the encrypted mail and sends as ordinary-text mail to the mail server (2) if the mail has not been falsified, and denies reception of mail if the mail has been falsified to prevent entry of falsified mail into LAN (1).

### BACKGROUND OF THE INVENTION

1. Field of the Invention

The present invention relates to a secure mail proxy system and a method of managing security for ensuring the security of electronic-mail, and to a recording medium in which a program is recorded.

2. Description of the Related Art

As systems for ensuring the security of electronic-mail, mail clients are widely used that are equipped with security capabilities such as: S/MIME (Secure Multipurpose Internet Mail Extension; Developed by RSA Data Security Inc.) for transmitting encrypted mail messages in MIME format; and PGP (Pretty Good Privacy; an encryption program developed by PGP Inc. in which the mail content is encrypted using a public key of the transmission partner and then transmitted).

One method typically used to realize effective functioning of security involves installing beforehand one's own secret key as well as the transmission partner's digital identification in the terminal that one is using.

However, systems of the prior art for ensuring the security of electronic-mail have the following problems:

The range of terminals that receive mail has increased from PC (personal computer) terminals of the prior art to terminals such as portable telephones, portable information terminals, and FAX (facsimile), and this range has further been augmented by terminals not having mail clients equipped with security functions, and as a result, mail security could not be ensured on the Internet.

In addition, the incorporation of security functions on the terminal side has been problematic in portable telephones, which have quickly become popular, and this weakness has been an important factor in preventing the use of the portable telephones for business.

### SUMMARY OF THE INVENTION

The present invention was achieved in view of the above-described problems, and has as an object the provision of a system and method, as well as a recording medium, that can ensure the security of electronic-mail on the Internet regardless of whether security functions are incorporated on the client side.

In the present invention for realizing the above-described object, a proxy server is arranged between a mail server and the Internet for carrying out processing relating to security of electronic-mail. This proxy server is provided with a means for encrypting and decrypting electronic-mail, attaching signatures, and detecting falsification, and thus can ensure security of electronic-mail on the Internet regardless of the type of mail server, mail client or user terminal that is used by the user and regardless of whether mail security functions are incorporated in the mail server, mail client, or user terminal.

In the present invention, a proxy server is arranged between a mail server and the Internet for carrying out processing relating to the security of electronic-mail. Ordinary-text mail that has not been encrypted or not bearing a signature is transmitted to a mail server from a mail client that is connected to a LAN, this mail server detects whether or not the address of this mail is in the LAN, and sends only mail having an address outside the LAN to a proxy server as ordinary text without alteration. The proxy server includes means for encrypting ordinary-text mail that has been received from a mail server such that only the mail recipient can decrypt the mail; and means for attaching the signature of the mail originator to the mail and transmitting the encrypted mail with attached signature to the Internet.

The proxy server further includes: means for, when encrypted mail with attached signature has been transmitted in by way of the Internet addressed to a mail server, checking whether or not the mail has been subjected to falsification, and if the mail has not been subjected to falsification, decrypting the encrypted mail to ordinary text and transmitting to the mail server; and means for, if mail has been subjected to falsification, rejecting the reception of the mail to prevent entry of the mail into the LAN.

The user uses the mail client to request the mail server for mail that has been received, and receives ordinary text mail from the mail server.

The above and other objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a block diagram showing the system configuration of the first embodiment of the present invention.

FIG. 2 is a block diagram showing an example of the construction of a proxy server in the first embodiment of the present invention.

FIG. 3 is a flow chart for explaining operations when sending mail from a mail client in the first embodiment of the present invention.

FIG. 4 is a flow chart for explaining operations when encrypted mail with attached signature has been received from the Internet in the first embodiment of the present invention.

FIG. 5 is a schematic view of an example of combinations of electronic-mail addresses and secret keys that are stored in the secret key storage unit in the first embodiment of the present invention.

FIG. 6 is a schematic view of an example of combinations of electronic-mail addresses and public keys that are stored in the public key storage unit in the first embodiment of the present invention.

FIG. 7 is a block diagram showing the system configuration of the second embodiment of the present invention.

FIG. 8 is a block diagram showing the system configuration of the third embodiment of the present invention.

### DETAILED DESCRIPTION OF THE PREFERRED EMBODIMENTS

Next, regarding an embodiment of the present invention, a proxy server for carrying out processing relating to the security of electronic-mail is arranged between the Internet and a mail server on a LAN (Local Area Network). This proxy server ensures the security of electronic-mail on the Internet regardless of the type of mail server, mail client or user terminal that is used by the user and regardless of whether security functions are incorporated in the mail server, mail client, or user terminal by performing encryption and decryption of electronic-mail as well as by attaching signatures and detecting falsification.

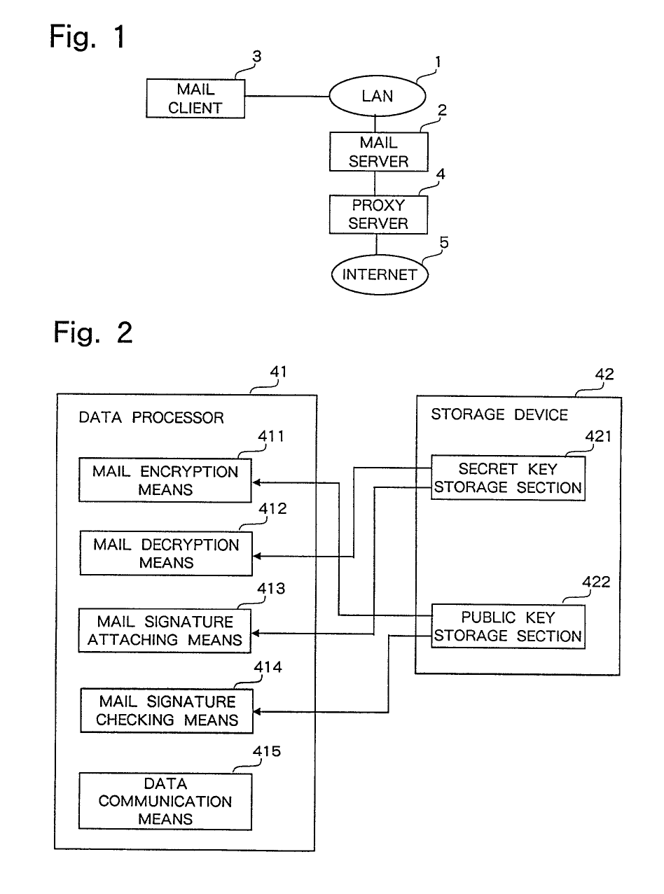

In FIG. 1, a user uses mail client 3 that is connected to LAN 1 to transmit ordinary-text mail that has not been encrypted or provided with a signature to mail server 2.

Mail server 2 checks whether or not the address of electronic-mail (hereinafter referred to as simply “mail”) is within LAN 1, and sends only mail addressed to destinations outside LAN 1 to proxy server 4 as ordinary text without alteration.

Proxy server 4 encrypts the ordinary-text mail that is received from mail server 2 such that only the mail recipient can decrypt the mail, attaches the signature of the mail sender, and sends the encrypted mail with attached signature to Internet 5.

When encrypted mail with attached signature addressed to mail server 2 is transmitted in from Internet 5, proxy server 4 checks whether or not the mail has been falsified.

If the mail has not been falsified, proxy server 4 decrypts the encrypted mail, and after converting it to ordinary-text mail, sends it to mail server 2.

If the mail has been subjected to falsification, proxy server 4 rejects the reception of the mail to prevent the entry of the falsified mail into LAN 1.

The user uses mail client 3 to request the mail that has been received at mail server 2 and receives the ordinary-text mail from mail server 2.

Next regarding a more detailed explanation of this embodiment with reference to the accompanying drawings, FIG. 1 is a block diagram showing the system architecture of the secure mail proxy system of the first embodiment of the present invention. Referring to FIG. 1, the first embodiment of the present invention is provided with: LAN 1, which is a local area network such as Ethernet; mail server 2, which is an information processor that is connected to LAN 1; mail client 3, which operates on a device such as a personal computer, portable telephone, portable information terminal, or FAX; proxy server, which is an information processor that intermediates between mail server 2 and Internet 5; and Internet 5.

FIG. 2 is a block diagram showing an example of the construction of proxy server 4 in the first embodiment of the present invention. Referring now to FIG. 2, proxy server 4 includes data processor 41 that operates under program control, and storage device 42 that stores information.

Storage device 42 is provided with secret key storage section 421 and public key storage section 422.

Secret key storage section 421 stores combinations of electronic-mail addresses (hereinafter referred to as simply “mail addresses”) and corresponding secret keys. The secret keys are used when attaching a sender's signature to electronic-mail, and when decrypting encrypted mail that has been transmitted to a mail address in LAN 1.

Public key storage section 422 stores combinations of electronic-mail addresses and corresponding public keys. Public keys are used when encrypting electronic-mail such that the mail can be read only by the user of the electronic-mail address that is designated in the address of the electronic-mail, and when checking whether or not electronic-mail has been falsified.

Data processor 41 is provided with: mail encryption means 411, mail decryption means 412, mail signature attaching means 413, mail signature checking means 414, and data communication means 415.

Mail encryption means 411 obtains the public key that corresponds to the electronic-mail address of an electronic-mail destination from public key storage section 422, and encrypts ordinary-text mail using the public key.

Mail decryption means 412 obtains the secret key that corresponds to the electronic-mail address of the electronic-mail destination from secret key storage section 421 and decrypts the encrypted electronic-mail using the secret key.

Mail signature attaching means 413 obtains the secret key that corresponds to the electronic-mail address of the electronic-mail originator from secret key storage section 421, calculates the electronic-mail message digest (hash value) and, after encrypting these values with the secret key, attaches them to the electronic-mail as the sender's signature.

Mail signature checking means 414 obtains, from public key storage section 422, the public key that corresponds to the electronic-mail address of the originator of received electronic-mail, uses the public key to decrypt the signature that is attached to the electronic-mail, and checks whether or not the electronic-mail has been falsified by comparing the values of the signature with the electronic-mail message digest (hash values).

Data communication means 415 receives ordinary-text mail from mail server 2 and transmits encrypted mail with attached signature to Internet 5, and further, receives encrypted mail with attached signature from Internet 5 and transmits ordinary-text mail to mail server 2.

In the first embodiment of the present invention, the processing and functions of mail encryption means 411, mail decryption means 412, mail signature attaching means 413, mail signature checking means 414, and data communication means 415 are realized by a program that is executed by data processor 41. In this case, the proxy server according to the present invention can be operated by reading the program from a recording medium (magnetic disk, magnetic tape, optical disk, or semiconductor memory) that stores the program to data processor 41 and then executing the program.

Referring now to FIGS. 1 to 6, a detailed explanation is next presented regarding the operation of the first embodiment of the present invention.

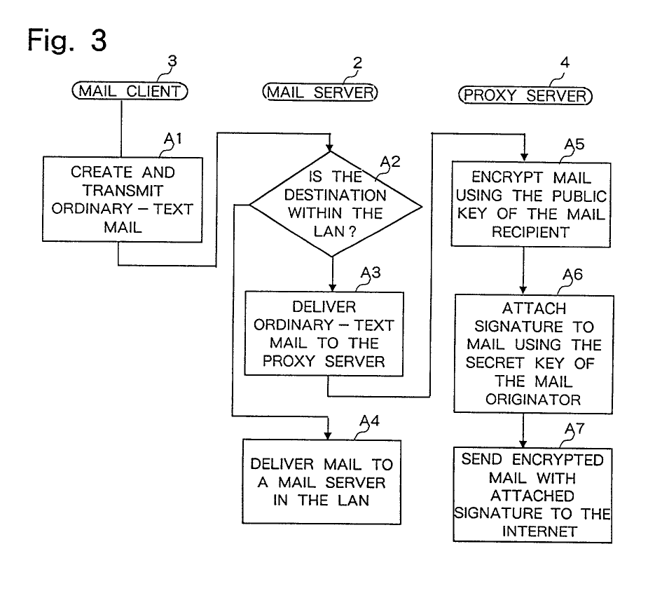

FIG. 3 is a flow chart for explaining operations when sending electronic-mail from mail client 3 in the first embodiment of the present invention. Explanation will begin with the transmission of electronic-mail from mail client 3.

The user creates electronic-mail using mail client 3 and sends the mail to mail server 2 as ordinary text (Step A1).

Mail server 2 checks whether or not the destination of the mail transmitted from mail client 3 is within LAN 1 (Step A2), sends the ordinary-text mail to proxy server 4 if addressed to a destination outside LAN 1 (Step A3), and if addressed to a destination within LAN 1, sends the electronic-mail as ordinary text without alteration to mail server 2 that is connected to LAN 1 (Step A4).

Proxy server 4 receives the ordinary-text mail from mail server 2 by means of data communication means 415, and by means of mail encryption means 411, obtains the public key that corresponds to the mail address of the destination of the electronic-mail from public key storage section 422, and encrypts the ordinary-text mail using the public key (Step A5).

FIG. 6 schematically shows an example of combinations of electronic-mail addresses and public keys that are stored in public key storage section 422.

If the mail address of the mail destination is “usuzuki@abc.com”, “111 . . . 001” is used as the corresponding public key in encryption.

By means of mail signature attaching means 413, proxy server 4 next obtains the secret key that corresponds to the electronic-mail address of the mail originator from secret key storage section 421, calculates the message digest (hash values) of the electronic-mail, and, after encrypting these values using the secret key, attaches them as the signature of the mail sender (Step A6).

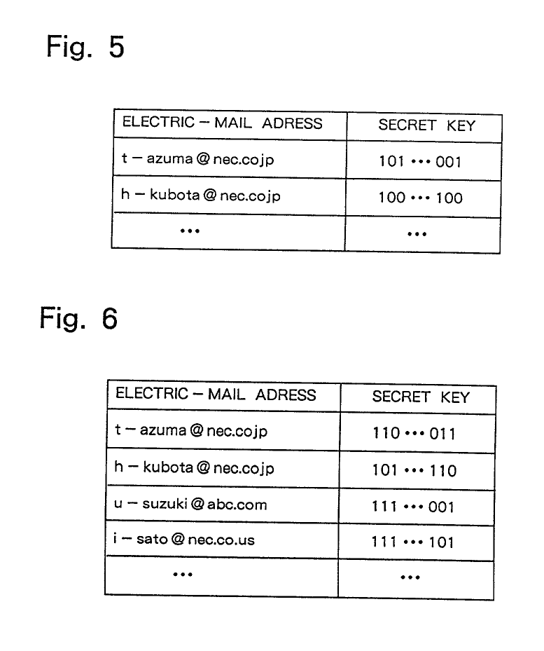

FIG. 5 shows an example of the combinations of electronic-mail addresses and secret keys that are stored in secret key storage section 421. If the electronic-mail address of the mail sender is “t-azuma@nec.co.jp”, “101 . . . 001” is used as the corresponding secret key in the signature.

Finally, proxy server 4 sends the encrypted mail with attached signature to Internet 5 by means of data communication means 415 (Step A7).

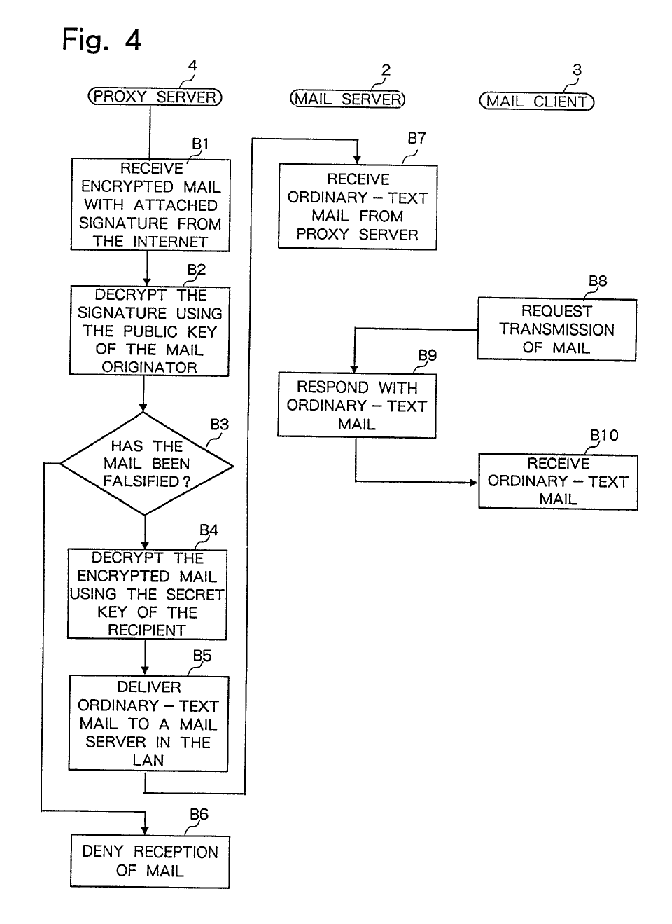

FIG. 4 is a flow chart for explaining the operation when receiving encrypted mail with attached signature from Internet 5 in the first embodiment of the present invention. The operations when receiving encrypted mail with attached signature from Internet 5 are next explained.

Proxy server 4 receives encrypted mail with attached signature from Internet 5 by means of data communication means 415 (Step B1).

By means of mail signature checking means 414, proxy server 4 obtains the public key that corresponds to the mail address of the mail originator from public key storage section 422, decrypts the signature that is attached to the electronic-mail using the public key (Step B2), and detects whether or not the electronic-mail has been falsified by comparing the values of the signature and the electronic-mail message digest (hash values) (Step B3).

In the example of FIG. 6, when the mail address of the mail originator is “u-suzuki@abc.com”, “111 . . . 001” is used as the corresponding public key for decrypting the signature.

If the electronic-mail has not been falsified, proxy server 4 uses mail decryption means 412 to obtain the secret key that corresponds to the mail address of the electronic-mail destination and decrypts the encrypted electronic-mail using the secret key (Step B4).

In the example shown in FIG. 5, if the mail address of the mail recipient is “t-azuma@nec.co.jp”, “101 . . . 001” is used as the corresponding secret key in the decryption of the encrypted message.

The message that has been decrypted to ordinary text is then sent to mail server 2 in LAN 1 by data communication means 415 (Step B5).

In a case in which the electronic-mail has been falsified, however, proxy server 4 rejects the reception of the mail to prevent the falsified mail from entering LAN 1 (Step B6).

Mail server 2 receives the ordinary-text mail from proxy server 4 (Step B7), and returns the ordinary-text mail to mail client [3] when there is a request from mail client 3 (Step B9).

The user uses mail client 3 to request mail server 2 for mail that has been received (Step B8), and receives ordinary-text mail from mail server 2 (Step B10).

Explanation next regards another embodiment of the present invention.

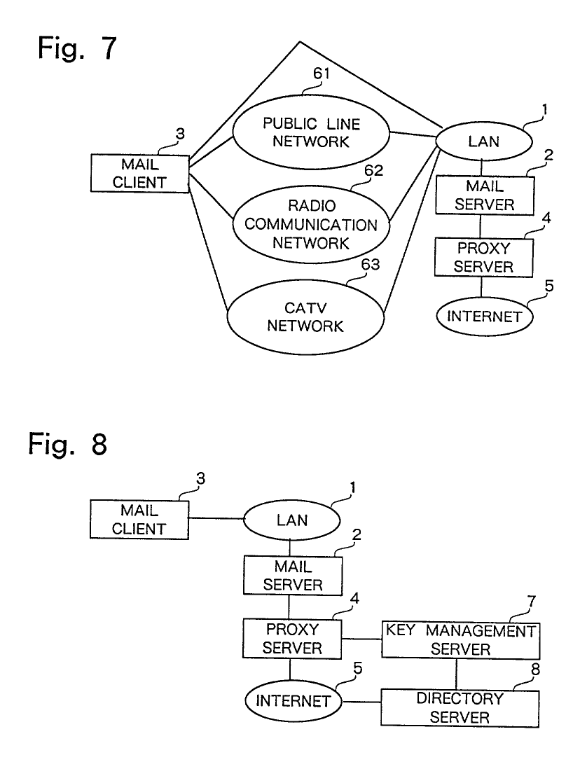

FIG. 7 is a block diagram showing the construction of the second embodiment of the present invention. Referring to FIG. 7, the second embodiment of the present invention may use any one or all of, for example, public line network 61, radio communication network 62, and CATV network 63 as a means for connecting mail client 3 to LAN 1 rather than connecting mail client 3 directly to LAN 1 as in the above-described embodiment.

A dial-up connection form is one example in which mail client 3 is connected to LAN 1 by way of public line network 61 using an Internet connection service provider (ISP).

As an example of connection to LAN 1 by way of radio communication network 62, connection is realized from a portable telephone by way of a portable telephone dealer that offers an Internet connection service.

As an example of a connection to LAN 1 by way of CATV (cable TV), connection is realized by way of a CATV company that offers an Internet connection service.

Next, regarding the third embodiment of the present invention, we refer to FIG. 8, which is a block diagram showing the construction of the third embodiment of the present invention. Referring to FIG. 8, the present embodiment includes key management server 7 and directory server 8, and proxy server 4 is not provided with private key storage section 421 and public key storage section 422.

Key management server 7 is a server provided exclusively for managing combinations of electronic-mail addresses and secret keys as shown in FIG. 5, and directory server 8 is provided exclusively for managing combinations of electronic-mail addresses and public keys, as shown in FIG. 6.

In this embodiment, mail encryption means 411 and mail signature checking means 414 of proxy server 4 acquire public keys from directory server 8.

In addition, mail decryption means 412 and mail signature attaching means 413 acquire secret keys from key management server 7.

Other than the acquisition of public keys and secret keys from directory server 8 and key management server 7, respectively, the processing procedure of proxy server 4 in the third embodiment of the present invention is similar to the procedures shown in FIG. 3 and FIG. 4.

As described in the foregoing explanation, the following effects can be obtained by the present invention:

As the first effect, the present invention can ensure mail security on the Internet without incorporating special software or devices in a terminal that transmits and receives mail.

The effect of the present invention to ensure security is particularly notable in systems that employ, as mail client terminals, the portable telephones and portable information terminals that have rapidly come into wide use. The present invention is effective both because of the great variety of devices to be treated and because of the huge number of units already in use.

The invention is effective because processing that is necessary for ensuring mail security in the present invention is allotted not to user-side terminals, but rather, to a proxy server that is arranged at the connection point with the Internet. The effect of the present invention is also notable because threats to security are far less serious inside the point at which an in-house LAN connects to the Internet than on the Internet itself, and security functions can be concentrated at the point of connection with the Internet.

The second effect of the present invention is a great reduction in management costs for ensuring security. This effect is particularly notable for a user that employs a plurality of terminals because security need not be established at each terminal.

The invention is effective because, in the present invention, the management of secret keys and public keys that are necessary for ensuring security is centralized at the proxy server and security settings are not required for each client.

It is to be understood, however, that although the characteristics and advantages of the present invention have been set forth in the foregoing description, the disclosure is illustrative only, and changes may be made in the arrangement of the parts within the scope of the appended claims.

What is claimed is:

1. A secure mail proxy system that is provided with a proxy server between a mail server on a LAN (Local Area Network) and the Internet for performing processing that is necessary for managing security such as encryption and attachment of signatures to electronic-mail that is transmitted from said mail server to said Internet and decryption and detection of falsification of encrypted mail with attached signature that has been received from said Internet.

2. A secure mail proxy system according to claim 1 in which a proxy server is arranged between a mail server on a LAN (Local Area Network) and the Internet for carrying out processing relating to security of electronic-mail, said proxy server comprising:
means for encrypting electronic-mail that has been received from said mail server, attaching a signature, and outputting to said Internet; and
means for, when encrypted mail with attached signature that is addressed to said mail server has been transmitted from said Internet, detecting whether or not falsification has occurred in said mail and, if no falsification has occurred, decrypting said encrypted mail and transmitting to said mail server;
said secure mail proxy system being capable of ensuring the security of electronic-mail on the Internet regardless of the type of mail server, mail client, or user terminal that is used by a user or whether or not security functions are incorporated in the mail server, mail client, or user terminal.

3. A secure mail proxy system according to claim 1 wherein:
a proxy server is arranged between a mail server on a LAN (Local Area Network) and the Internet for carrying out processing relating to security of electronic-mail;
ordinary-text electronic-mail is transmitted from a mail client to said mail server; and
said mail server checks whether or not the destination of said electronic-mail is in said LAN and transmits electronic-mail that has a destination outside said LAN to said proxy server as ordinary text without alteration;
said proxy server comprising:
means for encrypting ordinary-text electronic-mail that has been received from said mail server such that only the mail recipient can decrypt said electronic-mail;
means for attaching a signature of the mail originator to encrypted mail and transmitting the encrypted electronic-mail with attached signature to said Internet;
means for, in a case in which encrypted electronic-mail with attached signature has been transmitted by way of said Internet addressed to said mail server, checking whether said electronic-mail has been subjected to falsification, and if said electronic-mail has not been subjected to falsification, decrypting and converting said encrypted mail to ordinary-text mail and delivering to said mail server; and
means for, in a case in which said electronic-mail has been subjected to falsification, rejecting the reception of said electronic-mail to prevent the entry of falsified electronic-mail into said LAN;
wherein said mail client requests said mail server for received electronic-mail and obtains ordinary-text electronic-mail from said mail server.

4. A secure mail proxy system according to claim 3 wherein said mail client is either connected directly to said LAN or is connected to said mail server of said LAN by way of at least one of a public line network, a radio-communication network, and a cable television (CATV) network.

5. A secure mail proxy system according to claim 1 that includes: a LAN (Local Area Network); a mail server that is connected to said LAN; and a proxy server provided between said mail server and the Internet for performing processing relating to electronic-mail security;
said proxy server comprising:
a secret key storage means for storing combinations of electronic-mail addresses and secret keys that correspond to these electronic-mail addresses;
a public key storage means for storing combinations of electronic-mail addresses and public keys that correspond to these electronic-mail addresses; wherein:
said secret keys are used when attaching to electronic-mail the signature of the originator and when decrypting encrypted mail that has been transmitted in addressed to an electronic-mail address in said LAN; and
said public keys are used when encrypting mail such that only the user of the electronic-mail address that is designated in the electronic-mail destination can read the encrypted mail and when checking whether mail has been falsified;
said proxy server being further provided with a data processor that includes:
mail encryption means for obtaining from said public key storage means the public key that corresponds to the electronic-mail address of the electronic-mail destination and encrypting ordinary-text mail from said mail server using said public key;
mail signature attaching means for obtaining from said secret key storage means the secret key that corresponds to the mail address of the electronic-mail originator, calculating a message digest of said electronic-mail, and, after encrypting the calculated values using said secret key, attaching the encrypted values as the signature of the electronic-mail originator;
mail decryption means for obtaining from said secret key storage means the secret key that corresponds to the electronic-mail address of the electronic-mail destination, and decrypting encrypted mail using said secret key;
mail signature checking means for checking whether or not mail has been falsified by obtaining from said public key storage means the public key that corresponds to the mail address of an electronic-mail originator, decrypting the signature that is attached to mail using said public key; and comparing values of the signature with the message digest of the mail; and
data communication means for receiving ordinary-text electronic-mail from said mail server, transmitting encrypted mail with attached signature that has been created by said mail encryption means and said mail signature attaching means to said Internet, and further, receiving encrypted mail with attached signature from said Internet and transmitting ordinary-text mail that is obtained by way of said mail signature checking means and said mail decryption means to said mail server.

6. A secure mail proxy system according to claim 5 wherein said mail client is either connected directly to said LAN or is connected to said mail server of said LAN by way of at least one of a public line network, a radio-communication network, and a cable television (CATV) network.

7. A secure mail proxy system according to claim 5 wherein said proxy server is not provided with: a secret key storage means for storing combinations of electronic-mail addresses and secret keys that correspond to the electronic-mail addresses, and a public key storage means for storing combinations of electronic-mail addresses and public keys that correspond to the electronic-mail addresses; but rather:
said secure mail proxy system is provided with: an independent key management server for managing combinations of electronic-mail addresses and secret keys that correspond to the electronic-mail addresses; and an independent directory server for managing combinations of electronic-mail addresses and public keys that correspond to the electronic-mail addresses;
wherein said mail encryption means, said mail signature attaching means, said mail decryption means, and said mail signature checking means of said proxy server each access said directory server and said key management server and obtain public keys and secret keys.

8. A proxy server that is arranged between a mail server that is connected to a LAN (Local Area Network) and the Internet for performing processing relating to electronic-mail security; is provided with:
a storage device that includes:
a secret key storage section for storing combinations of electronic-mail addresses and secret keys that correspond to the electronic-mail addresses; and
a public key storage section for storing combinations of electronic-mail addresses and public keys that correspond to the electronic-mail addresses;
wherein said secret keys are used when attaching the signature of an originator to electronic-mail and when decrypting encrypted electronic-mail that has been transmitted in to an electronic-mail address in said LAN; and
said public keys are used when encrypting mail such that only the user of the electronic-mail address that is designated in the electronic-mail destination can read the encrypted mail and when checking whether mail has been falsified;
said proxy server being further provided with a data processor that includes:
mail encryption means for obtaining from said public key storage section the public key that corresponds to the electronic-mail address of the electronic-mail destination and encrypting ordinary-text mail from said mail server using said public key;
mail signature attaching means for obtaining from said secret key storage section the secret key that corresponds to the mail address of an electronic-mail originator, calculating a message digest of said electronic-mail, and, after encrypting the calculated values using said secret key, attaching the encrypted values as the signature of the electronic-mail originator;
mail decryption means for obtaining from said secret key storage section the secret key that corresponds to the electronic-mail address of the electronic-mail destination, and decrypting encrypted mail using said secret key;
mail signature checking means for checking whether or not mail has been falsified by obtaining from said public key storage section the public key that corresponds to the mail address of an electronic-mail originator, decrypting the signature that is attached to electronic-mail using said public key; and comparing values of the signature with the message digest of the electronic-mail; and
data communication means for receiving ordinary-text electronic-mail from said mail server, transmitting encrypted mail with attached signature that has been created by said mail encryption means and said mail signature attaching means to said Internet, and further, receiving encrypted mail with attached signature from said Internet and transmitting ordinary-text mail that is obtained by way of said mail signature checking means and said mail decryption means to said mail server.

9. A method of managing security of electronic-mail that is transmitted and received between a mail server and the Internet in which a proxy server is provided between a mail server on a LAN (Local Area Network) and the Internet for performing processing relating to electronic-mail security, comprising steps in which:
said proxy server encrypts and attaches a signature to electronic-mail that is to be transmitted to said Internet; and
said proxy server checks for falsification of electronic-mail that is addressed to said mail server from said Internet and decrypts said electronic-mail;
wherein processes necessary for managing security of electronic-mail are performed by said proxy server that is arranged at the point of connection to said Internet;
whereby the security of electronic-mail on the Internet can be ensured regardless of the type of mail server, mail client, or user terminal that is used by the user and regardless of whether the mail server, mail client or user terminal used by the user incorporates security functions.

10. A method of managing security of electronic-mail according to claim 9 wherein a proxy server is arranged between a mail server that is connected to a LAN (Local Area Network) and the Internet; comprising steps in which:
said mail server that has received ordinary-text electronic-mail from a mail client checks whether or not the destination of said electronic-mail is within said LAN and transmits electronic-mail having a destination outside said LAN to said proxy server as ordinary-text without alteration;
said proxy server encrypts ordinary-text electronic-mail that is sent from said mail server such that only the mail recipient can decrypt said electronic-mail;
the signature of the mail originator is attached and the encrypted electronic-mail with attached signature is transmitted to the Internet;
when encrypted electronic-mail with attached signature has been transmitted in over said Internet addressed to said mail server, said proxy server checks whether or not said electronic-mail has been falsified;
if said electronic-mail has not been falsified, said encrypted electronic-mail is decrypted to ordinary-text mail and then delivered to said mail server;
if said electronic-mail has been falsified, the reception of said electronic-mail is rejected to prevent entry of the falsified electronic-mail into said LAN; and
said mail client is used by the user to request said mail server for received electronic-mail and to receive ordinary-text electronic-mail from said mail server.

11. A method of managing security of electronic-mail according to claim 9, wherein the step in which said proxy server encrypts and attaches a signature to electronic-mail that is to be transmitted to said Internet includes steps in which:
a user uses a mail client to create electronic-mail and send the electronic-mail to a mail server as ordinary text without alteration;
said mail server checks whether or not the destination of electronic-mail that has been transmitted from said mail client is within the LAN (Local Area Network) to which said mail server is connected;
ordinary-text electronic-mail is delivered to said proxy server when the destination of said electronic-mail is outside said LAN;
said proxy server receives ordinary-text electronic-mail from said mail server, obtains the public key that corresponds to the electronic-mail address of the destination of said electronic-mail from a public key storage section that stores combinations of electronic-mail addresses and corresponding public keys that correspond to electronic-mail addresses, and encrypts said ordinary-text electronic-mail using the public key;
said proxy server obtains the secret key that corresponds to the electronic-mail address of the originator of said electronic-mail from a secret key storage section that stores combinations of electronic-mail addresses and secret keys that correspond to the electronic-mail addresses, calculates a message digest of said electronic-mail, encrypts these calculated values using the secret key, and attaches these encrypted values to said electronic-mail as the signature of the originator; and
said proxy server sends encrypted mail with attached signature to the Internet.

12. A method of managing security of electronic-mail according to claim 9 wherein the step in which said proxy server checks for falsification of electronic-mail addressed to said mail server from said Internet and decrypts said electronic-mail includes steps in which:
said proxy server receives encrypted electronic-mail with attached signature from said Internet;
said proxy server obtains from said public key storage section the public key that corresponds to the mail address of the electronic-mail originator and decrypts the signature attached to said electronic-mail with said public key;
falsification of said electronic-mail is checked by comparing values of the signature with the message digest of said electronic-mail;
if said electronic-mail has not been falsified, said proxy server obtains from said secret key storage section the secret key that corresponds to the mail address of the destination of said electronic-mail and decrypts said electronic-mail using said secret key;
electronic-mail that has been decrypted to ordinary text is delivered to said mail server in said LAN;
if said electronic-mail has been falsified, said proxy server rejects the reception of the mail to prevent entry of falsified electronic-mail into said LAN;
said mail server receives ordinary-text electronic-mail from said proxy server; and
the user uses said mail client to request said mail server for mail that has been received and receives ordinary-text mail from said mail server.

13. A recording medium on which is recorded a program for performing processing relating to security of electronic-mail between a mail server that is connected to a LAN (Local Area Network) and the Internet using a proxy server;
wherein a storage device is provided that is in turn provided with:
a secret key storage section for storing combinations of electronic-mail addresses and secret keys that correspond to these electronic-mail addresses, and
a public key storage section for storing combinations of electronic-mail addresses and public keys that correspond to these electronic-mail addresses;
wherein said secret key is used when attaching to electronic-mail the signature of the originator and when decrypting encrypted mail that has been transmitted in to an electronic-mail address in said LAN; and
said public key is used when encrypting electronic-mail such that only the user of the electronic-mail address that is designated in the destination of the electronic-mail can read said electronic-mail and when checking for falsification of electronic-mail;
a program being recorded on said recording medium for causing a computer that constitutes said proxy server to execute the following processes from (a) to (e):
(a) a mail encrypting process in which the public key that corresponds to the electronic-mail address of the destination of electronic-mail is obtained from said public key storage section and ordinary-text mail is encrypted using the public key;
(b) a mail signature attaching process in which the secret key that corresponds to the mail address of the originator of electronic-mail is obtained from said secret key storage section, a message digest of said electronic-mail is calculated; the calculated values are encrypted using the secret key and the encrypted values are attached to electronic-mail as the signature of the originator;
(c) a mail decryption process in which the secret key that corresponds to the electronic-mail address of the electronic-mail destination is obtained from said secret key storage section and encrypted mail is decrypted using the secret key;
(d) a mail signature checking process in which the public key that corresponds to the mail address of the originator of electronic-mail is obtained from said public key storage section, a signature that is attached to mail is decrypted using the public key, and falsification of mail is checked by comparing values of the signature and the message digest of the mail; and
(e) a data communication process in which ordinary-text mail is received from said mail server, encrypted mail with attached signature is transmitted to the Internet, encrypted mail with attached signature is received from said Internet, and ordinary-text mail is transmitted to said mail server.
